(19) United States
(12) Patent Application Publication
(10) Pub. No.: US 2025/0196975 A1
(43) Pub. Date: Jun. 19, 2025

(54) FLOATING PLATFORM SUPPORT SYSTEM WITH PASSIVE IN-PLANE FLUID DAMPERS

(71) Applicant: Kent Houston Offshore Engineering LLC, Houston, TX (US)

(72) Inventors: Ikpoto E. Udoh, Texas City, TX (US); Vimal Vinayan, Houston, TX (US); Quan Chen, Katy, TX (US)

(21) Appl. No.: 18/542,613

(22) Filed: Dec. 16, 2023

(51) Int. Cl. B63B 39/03; B63B 21/20; B63B 35/34; B63B 35/44; F03D 13/25

(52) U.S. Cl. CPC B63B 39/03; B63B 21/20; B63B 35/34; B63B 35/44; B63B 2021/203; B63B 2035/446; F03D 13/256; F05B 2240/93; F05B 2240/95

(57) ABSTRACT

A support system includes a platform for floatation at a surface of a body of water. The platform includes a first pontoon and a set of second pontoons coupled to the first pontoon. Each second pontoon includes a container, a pair of spaced-apart and gas-filled compressible elements disposed in the container, a liquid filling the container between the pair of compressible elements, and a gas flow controller coupled to each compressible element and operable to control a flow of the gas between the compressible elements.

### FIELD OF THE DISCLOSURE

This disclosure relates generally to floating platform structures, and more particularly to methods and systems for floating platforms whose dynamic response to environment-induced motion may be damped by passive in-plane fluid dampers.

### BACKGROUND

A variety of marine structures may be deployed at offshore locations. Such marine structures may include offshore floating platforms and structures used for wind turbines. In terms of the future of wind turbine design, one such design is a buoyant platform tethered to the sea floor by mooring lines (as is the case for semi-submersible platforms as is known in the art) that must support a very large tubular tower (e.g., on the order of hundreds of feet) with a nacelle mounted at the top of the tower. Rotor blades up to 200 feet or more in length are attached to the nacelle using mechanical and electrical equipment mounted in the nacelle. In order to support such large towers and rotor blades, a wind turbine's floating support platform may need to be quite large in order to compensate for the dynamics of the wind turbine system that will be subjected to environment-induced wave and wind-generated motion. Unfortunately, floating platforms large enough to compensate for wave and wind-generated motion require high capital expenditures that may make large wind turbines impractical or impossible to justify.

Rather than relying on a large floating platform for the support of a wind turbine, active and passive control systems have been contemplated for use in “absorbing” or damping wave/wind-induced dynamics acting on a wind turbine system. Active control systems typically rely on an external source of power to constantly power a damping mechanism. This leads to increased operational costs due to the need for constant application of power as well as maintenance. Passive control system approaches are typically based on “tuned mass dampers” (TMD) that are only impactful over some targeted and narrow range of frequencies based on the mass of the structure being damped. Unfortunately, floating-platform-supported wind turbines are subject to several frequencies at which dynamic responses could be the source of structural resonance. In addition, TMDs are extremely difficult to tune in an in-situ field environment such as the open ocean. Accordingly, TMDs do not provide an effective and reliable solution to the damping of varying types of motion or resonance that will be experienced by an offshore, floating-platform-supported wind turbine.

### SUMMARY

Accordingly, it is an object of the present disclosure to describe methods and systems for damping motion of offshore floating platforms.

Another object of the present disclosure is to describe methods and systems for passively damping motion of offshore floating platforms.

Still another object of the present disclosure is to describe methods and systems for damping a variety of environment-induced movements of an offshore floating platform used to support a wind turbine system.

Other objects and advantages of the methods and systems described herein will become more obvious hereinafter in the specification and drawings.

In accordance with methods and systems described herein, a support system includes a platform adapted to float at a surface of a body of water. The platform includes a first pontoon and a set of second pontoons coupled to the first pontoon. Each second pontoon includes a container, a pair of spaced-apart and gas-filled compressible elements disposed in the container, a liquid filling the container between the pair of compressible elements, and a gas flow controller coupled to each compressible element and operable to control a flow of the gas between the compressible elements.

### BRIEF DESCRIPTION OF THE DRAWINGS

Other objects, features and advantages of the methods and systems described in the present disclosure will become apparent upon reference to the following description of the preferred embodiments and to the drawings, wherein corresponding reference characters indicate corresponding parts throughout the several views of the drawings and wherein:

FIG. 1 is a schematic view of one embodiment of a floating platform support system having passive in-plane fluid dampers in accordance with various aspects as described herein;

FIG. 2 is a schematic view of another embodiment of a floating platform support system having passive in-plane fluid dampers in accordance with various aspects as described herein;

FIG. 3 is an isolated schematic view of one embodiment of a fluid damper in accordance with various aspects as described herein;

FIG. 4 is an isolated plan view of one embodiment of a motion-damping pontoon to include a fluid damper in accordance with various aspects as described herein;

FIG. 5A is a plan view of one embodiment of a floating platform support system having a triangular central pontoon with a motion-damping pontoon coupled to each corner of the central pontoon in accordance with various aspects as described herein;

FIG. 5B is a plan view of another embodiment of a floating platform support system having a square central pontoon with a motion-damping pontoon coupled to each corner of the central pontoon in accordance with various aspects as described herein;

FIG. 6 is a perspective view of a floating platform support system illustrating one embodiment of a base portion of a tower mounted on the platform in accordance with various aspects as described herein; and

FIG. 7 is a schematic view of another embodiment of a floating platform support system that includes a hybrid tower structure in accordance with various aspects as described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure. However, it will be readily apparent to one of ordinary skill in the art that the present disclosure may be practiced without limitation to these specific details.

The present disclosure describes support systems and methods for passively damping out unwanted motion of a floating platform and any structure supported thereby that may be induced by environmental forces. For example, when the support system is deployed at an offshore location for support of a wind turbine, relevant environmental forces include wind, waves, and water currents. In the presence of such varying and/or cyclical environmental forces, a floating platform and its supported structure may experience movement and resonation at a variety of frequencies.

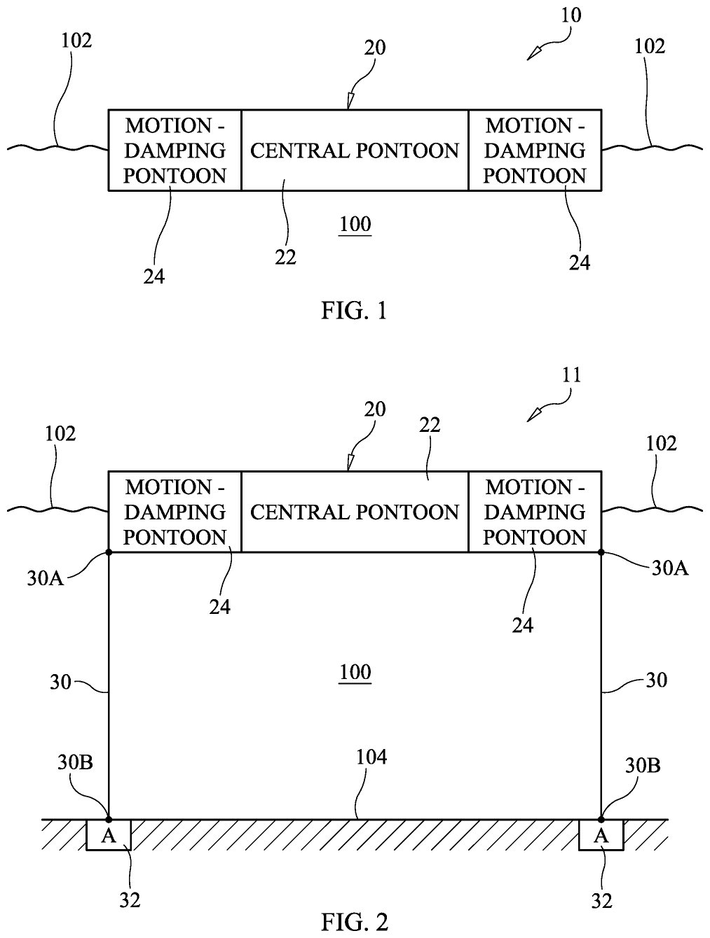

Referring now to the drawings and more particularly to FIGS. 1 and 2, two embodiments of a floating platform support system in accordance with the present disclosure are illustrated schematically. FIG. 1 illustrates a free-floating platform support system that is referenced generally by numeral 10. FIG. 2 illustrates a tethered (or moored) floating platform support system that is referenced generally by numeral 11. Each of support systems 10 and 11 includes a platform 20 configured for flotation at or near the surface 102 of a body of water 100. Platform 20 may be configured, sized, and constructed in a variety of ways without departing from the scope of the present disclosure. Several non-limiting embodiments of platform 20 will be presented later herein. In some embodiments, support system 11 may include a supported structure such as a wind turbine's tower, nacelle, and blades.

In both support systems 10 and 11, platform 20 includes a central pontoon 22 and a set of motion-damping pontoons 24 coupled to central pontoon 22. In some embodiments, motion-damping pontoons 24 may be coupled to a periphery of central pontoon 22 and extend outward therefrom. In some embodiments, one or more of motion-damping pontoons 24 may be integrated or incorporated into central pontoon 22. In some embodiments, one or more of motion-damping pontoons 24 may be tangentially positioned relative to central pontoon 22. In some embodiments, central pontoon 22 and motion-damping pontoons 24 lie in a common plane at or near surface 102. Each motion-damping pontoon 24 may be configured to include a fluid damper as will be described further below.

As mentioned above, floating platform support system 10 is free-floating, while support system 11 is tethered or moored to the bottom 104 of the body of water 100. In terms of supporting a structure such as a wind turbine in a preferred orientation in the body of water 100, the tethered floating platform system 11 will generally be used. Accordingly, by way of example, the remainder of the present disclosure will focus on tethered floating platform support system 11.

In tethered or moored support systems such as support system 11, one or more mooring elements or mooring lines may be used to tether the platform to the bottom of the body of water. For example, support system 11 illustrates one such embodiment where each of support system 11's motion-damping pontoons 24 has one or more mooring elements or mooring lines 30 connected at one end 30A to a pontoon 24 and connected at another end 30B (i.e., anchored) to a location at the bottom 104 of the body of water 100. In some embodiments, end 30A is coupled to an outboard end of its corresponding pontoon 24. Each anchored end 30B of a mooring element 30 may be attached to an anchor (“A”) 32 embedded in the bottom 104 of the body of water 100. In general, each mooring element 30 is either in tension or under slack (depending on the movement of the platform structure) such that the set of mooring elements 30 associated with support system 11 keeps platform 20 substantially at its installed vicinity and at a generally horizontal orientation, while allowing platform 20 to experience what will be referred to herein as “shifted movements” along and about (i.e., vertical movements and rotations) the surface 102 of the body of water 100. Such shifted movements are generally caused by one or more of wind, waves, and water currents acting on platform 20 or any structure (not shown in FIGS. 1 and 2) supported on platform 20.

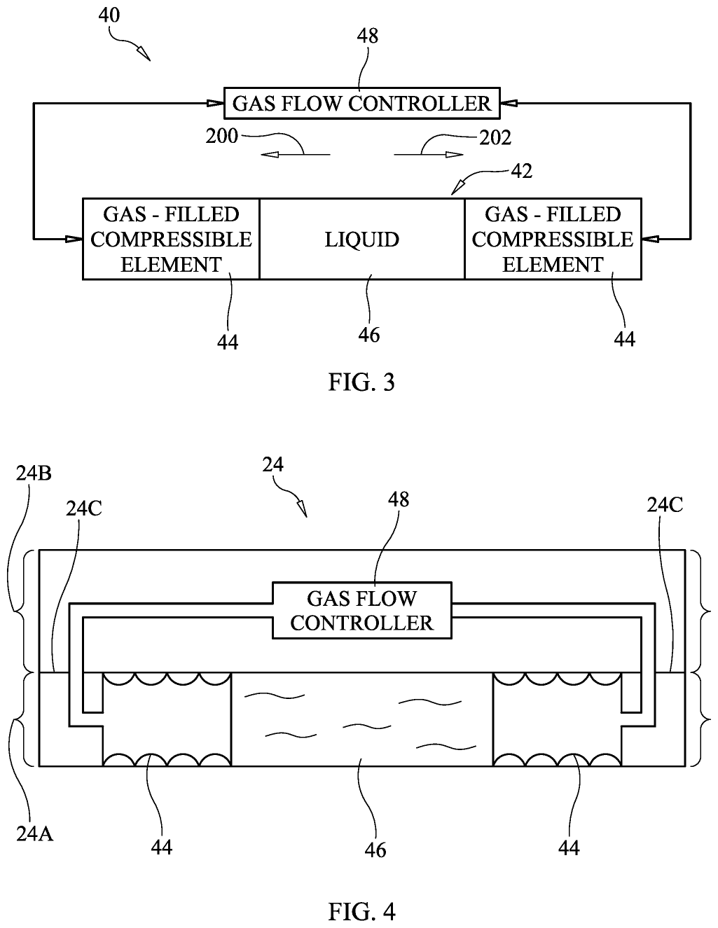

Support system 11 passively damps the above-described environmentally-induced shifted movements of platform 20 using the set of motion-damping pontoons 24 in order to prevent support system 11 (and any structure supported thereon) from resonating at one or more frequencies at which damage may occur. Referring now to FIG. 3, an embodiment of a fluid damper for use in either of support systems 10 or 11 is illustrated schematically and is referenced generally by numeral 40. In general, fluid damper 40 may be a closed system having a liquid-filled portion and a gas-filled portion where shifting movement of the fluid damper in either direction 200 or 202 may be damped. More specifically, fluid damper 40 includes a rigid container 42 housing a pair of spaced-apart gas-filled compressible elements 44 and a liquid 46 filling the region of container 42 between compressible elements 44. As a result of this structure, either of shifting movements 200 or 202 causes a shift of momentum of liquid 46 as will be described further below. Examples of liquid 46 include, but are not limited to, water, water mixed with an additive (e.g., antifreeze), liquids other than water or water mixtures, etc. Examples of a compressible element 44 include, but are not limited to a flexible diaphragm coupled/sealed at its periphery to an end of container 42 to thereby define a gas-filled compressible element, a sealed bellows disposed in container 42, a sliding piston sealed to the inside perimeter of container 42, rolling diaphragms, etc.

A gas flow controller 48 is coupled to each of compressible elements 44 to control the flow of gas between compressible elements 44. That is, gas flow controller 48 is in fluid communication with the gas-filled regions of both compressible elements 44. In general, controller 48 may be operable to balance the gas pressure acting on each of compressible elements 44 to thereby oppose the momentum of liquid 46 caused by either of motions 200 or 202 of container 42. By opposing shifting momentum of liquid 46, fluid damper 40 effectively damps the motion 200 or 202 of container 42 that causes the shifting momentum of liquid 46. Examples of gas flow controller 48 include, but are not limited to, an orifice plate having one or more holes, a pressure-sensing two-way valve, a flow restricting pipe(s), a venturi, etc.

The features of fluid damper 40 may be incorporated into a motion-damping pontoon 24 of support system 10 or 11 in a variety of ways without departing form the scope of the present disclosure. For example and with reference to the isolated plan view depicted in FIG. 4, a single motion-damping pontoon 24 of a support system 10 or 11 is illustrated. In the illustrated example, pontoon 24 is a rigid and sealed housing that includes two chambers 24A and 24B that may be adjacent to one another and share a common wall 24C as shown. Chamber 24A serves as the above-described container 42 housing the above-described gas-filled compressible elements 44 (e.g., bellows in the illustrated example) and liquid 46 (e.g., water) filling the region between compressible elements 44. Housed in chamber 24B is the above-described gas flow controller 48 as well as a conduit 49 that provides fluid communication between each of compressible elements 44 and gas flow controller 48.

As mentioned above, platform 20 may be configured in a variety of ways without departing from the scope of the present disclosure. For example, a floating platform's central pontoon 22 in accordance with the present disclosure may have a footprint at or near the water's surface defined by a polygonal shape having vertices or corners. Such polygonal shapes may include triangles, rectangles, or other multi-sided polygons. In some embodiments, the polygonal shape may utilize identical-length sides (e.g., equilateral triangle, square, etc.) to simplify both the above-described vertical support and motion damping using symmetrical arrangements of support and damping features.

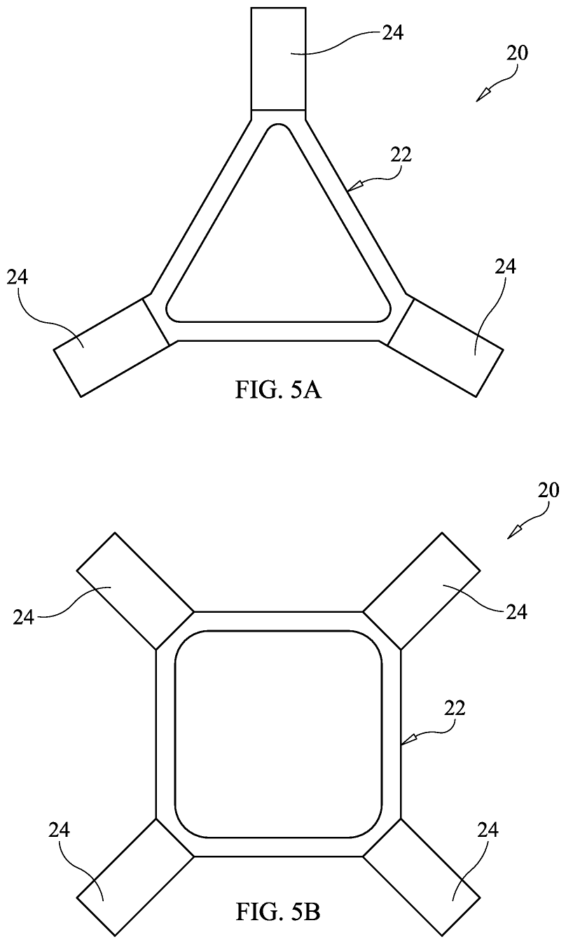

Referring now to FIGS. 5A and 5B, two non-limiting examples of a floating platform 20 to include its central pontoon 22 and motion-damping pontoons 24 in accordance with the present disclosure are illustrated in isolated plan views. In FIG. 5A, platform 20 is configured such that the outer periphery of its central pontoon 22 defines or approximates an equilateral triangle with a motion-damping pontoon 24 coupled to each of the central pontoon's vertices such that the set of motion-damping pontoons 24 are evenly distributed about and extend away from central pontoon 22. In FIG. 5B, platform 20 is configured such that the outer periphery of central pontoon 22 defines or approximates a square with a motion-damping pontoon 24 coupled to each of the central pontoon's corners such that the set of motion-damping pontoons 24 are evenly distributed about and extend away from central pontoon 22.

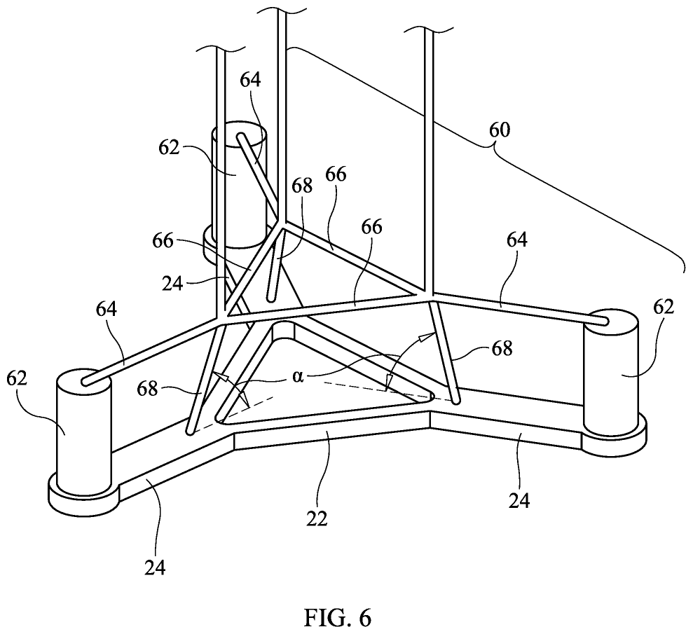

As mentioned above, a structure (e.g., a wind turbine tower) may be coupled to a floating platform system described in the present disclosure. In some embodiments a tower structure may include an open-framework base coupled to the floating platform. For example and with reference to FIG. 6, a floating platform 20 (e.g., having a triangular central pontoon 22) is illustrated with an open-framework base 60 of a tower (not shown) that is to be supported by a floating platform 20. In the illustrated example, base 60 includes support columns 62 coupled to outboard ends of motion-damping pontoons 24. Horizontal frame members 64 coupled to columns 62 extend to a central frame 66 that mimics the geometric shape of central pontoon 22 and is parallel to central pontoon 22. Inclined frame members 68 extend at an acute angle α from an inboard portion of a corresponding motion-damping pontoon 24 to a terminus at central frame 66 that is disposed over central pontoon 22. The inclusion of inclined frame members 68 provides a stiff connection between base 60 and a tower (not shown) coupled to base 60.

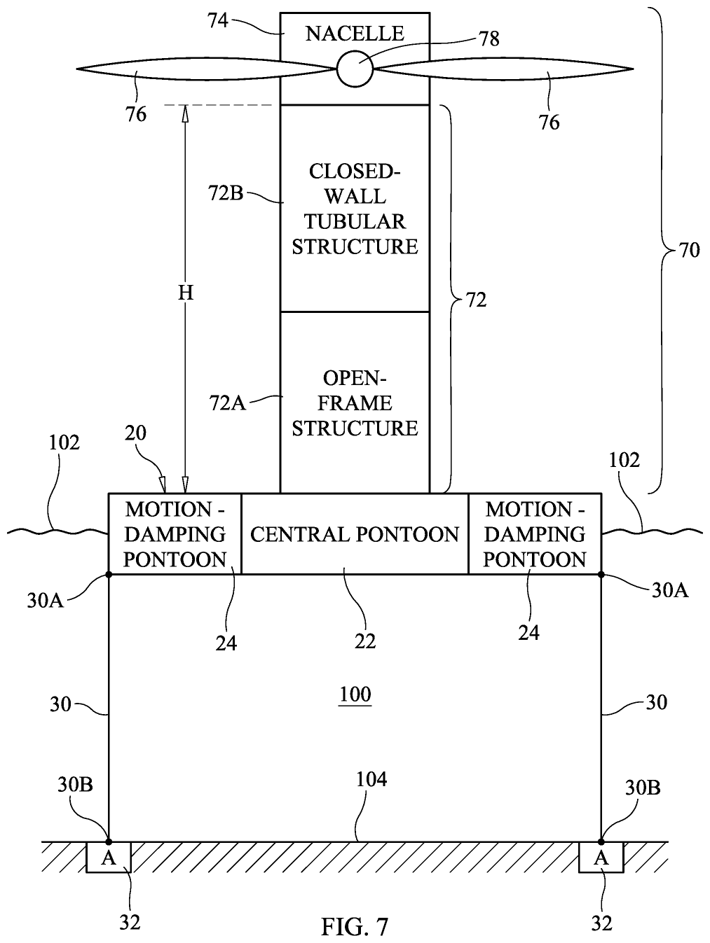

As also mentioned above, support systems in accordance with the present disclosure may include a supported structure disposed on a tethered version of the support system's platform. For example, a wind turbine may be mounted on the support system's platform. In general and as is well-known in the art, wind turbines include a tubular solid-wall support tower, a nacelle housing a generator, gear box, bearings, etc. mounted atop the support tower, and blades coupled to a rotating hub extending from the nacelle. In accordance with the present disclosure and as illustrated in FIG. 7, the above described support system may include a wind turbine 70 that includes a hybrid tower 72, a nacelle 74 (housing a generator, gear box, bearings, etc.), and blades 76 coupled to a rotating hub 78 extending from nacelle 74. In accordance with an aspect of the present disclosure, hybrid tower 72 includes a lower portion 72A constructed as an open-frame structure (e.g., an open frame construction that may include a base as described above and shown in FIG. 6) and an upper portion 72B constructed as a closed-wall tubular structure (i.e., solid outer walls). The height of upper portion 72B may be up to approximately 50% of the overall height “H” of tower 72. The open framework of lower portion 72A will make it less susceptible to wind impacts, while the closed outer wall structure of upper portion 72B will allow tower 72 to interface with the components at the top of tower 72 in accordance with currently-accepted and approved constructions.

The advantages of the systems and methods described herein are numerous. The disclosed floating platform support system passively damps shifted movement of a floating platform. The multiple motion dampers may be distributed about the periphery of a floating platform support system to damp the platform's shifted movements in a variety of directions. Since each motion damper operates independently, the support system is able to adapt to and damp motion over a variety of frequencies thereby making the support system ideally suited for inclusion as part of an offshore wind turbine installation.

Although the methods and systems presented herein have been described for specific embodiments thereof, there are numerous variations and modifications that will be readily apparent to those skilled in the art in light of the above teachings. For example, motion dampers described herein may additionally or alternatively be disposed along sides of a platform. The hybrid tower described herein may also be used with other types of floating or land-based installations. It is therefore to be understood that, within the scope of the appended claims, the methods and systems presented herein may be practiced other than as specifically described.

What is claimed as new and desired to be secured by Letters Patent of the United States is:

1. A support system, comprising:
a platform adapted to float at a surface of a body of water, said platform including a first pontoon and a set of second pontoons coupled to said first pontoon; and
each second pontoon from said set of second pontoons including
a container,
a pair of spaced-apart compressible elements disposed in said container, each compressible element from said pair being filled with a gas,
a liquid filling said container between said pair, and
a gas flow controller coupled to said each compressible element and operable to control a flow of said gas between said pair.

2. The support system of claim 1, further comprising a set of mooring elements, each mooring element from said set of mooring elements coupled to one of said second pontoons and adapted to be coupled to a bottom of the body of water.

3. The support system of claim 1, wherein a periphery of said first pontoon comprises a polygonal shape having corners, and wherein one of said second pontoons is coupled to each of said corners.

4. The support system of claim 1, further comprising a tower coupled to said platform and adapted to extend above the surface of the body of water, said tower including an open frame structure rigidly coupled to said platform and a closed tubular structure rigidly coupled to said open frame structure.

5. The support system of claim 4, wherein said tower has a height, and wherein said closed tubular structure comprises up to approximately 50% of said height.

6. The support system of claim 1, further comprising a tower coupled to said platform and adapted to extend above the surface of the body of water, said tower including an open frame structure rigidly coupled to said platform, wherein said open frame structure includes a set of frame members rigidly coupled to said set of second pontoons, and wherein each of a portion of said frame members extends from a corresponding one of said second pontoons to a terminus disposed over said first pontoon.

7. The support system of claim 1, wherein said first pontoon and said second pontoons lie in a common plane.

8. The support system of claim 1, wherein said second pontoons are evenly distributed about said first pontoon.

9. A support system, comprising:
a platform adapted to float at a surface of a body of water, said platform including a central pontoon and a set of peripheral pontoons distributed about and coupled to said central pontoon;
each peripheral pontoon from said set of peripheral pontoons including
a container,
a pair of spaced-apart compressible elements disposed in said container, each compressible element from said pair being filled with a gas,
a liquid filling said container between said pair, and
a gas flow controller coupled to said each compressible element and operable to control a flow of said gas between said pair; and
a set of mooring elements, each mooring element from said set of mooring elements connected to an outboard end of one of said peripheral pontoons and adapted to be connected to a bottom of the body of water.

10. The support system of claim 9, wherein a periphery of said central pontoon comprises a polygonal shape having corners, and wherein one of said peripheral pontoons is coupled to each of said corners.

11. The support system of claim 9, further comprising a tower coupled to said platform and adapted to extend above the surface of the body of water, said tower including an open frame structure rigidly coupled to said platform and a closed tubular structure rigidly coupled to said open frame structure.

12. The support system of claim 11, wherein said tower has a height, and wherein said closed tubular structure comprises up to approximately 50% of said height.

13. The support system of claim 9, further comprising a tower coupled to said platform and adapted to extend above the surface of the body of water, said tower including an open frame structure rigidly coupled to said peripheral pontoons, said open frame structure including a set of frame members rigidly coupled to said set of peripheral pontoons, wherein each of a portion of said frame members angularly extends from an inboard region of a corresponding one of said peripheral pontoons to a terminus disposed over said central pontoon.

14. The support system of claim 9, wherein said central pontoon and said peripheral pontoons lie in a common plane.

15. A support system, comprising:
a platform adapted to float at a surface of a body of water, said platform including a first pontoon and a set of second pontoons coupled to said first pontoon; and
each second pontoon from said set of second pontoons including
a container having a first chamber and a second chamber,
a pair of spaced-apart compressible elements disposed in said first chamber, each compressible element from said pair being filled with a gas,
a liquid filling said first chamber between said pair, and
a gas flow controller disposed in said second chamber, in fluid communication with said each compressible element, and operable to control a flow of said gas between said pair.

16. The support system of claim 15, further comprising a set of mooring elements, each mooring element from said set of mooring elements connected to one of said second pontoons and adapted to be connected to a bottom of the body of water.

17. The support system of claim 15, wherein a periphery of said first pontoon comprises a polygonal shape having corners, and wherein one of said second pontoons is coupled to each of said corners.

18. The support system of claim 15, further comprising a tower coupled to said platform and adapted to extend above the surface of the body of water, said tower including an open frame structure rigidly coupled to said platform and a closed tubular structure rigidly coupled to said open frame structure.

19. The support system of claim 18, wherein said tower has a height, and wherein said closed tubular structure comprises up to approximately 50% of said height.

20. The support system of claim 15, further comprising a tower coupled to said platform and adapted to extend above the surface of the body of water, said tower including an open frame structure rigidly coupled to said platform, wherein said open frame structure includes a set of frame members rigidly coupled to said set of second pontoons, and wherein each of a portion of said frame members angularly extends from a corresponding one of said second pontoons to a terminus disposed over said first pontoon.

21. The support system of claim 15, wherein said first pontoon and said second pontoons lie in a common plane.

22. The support system of claim 15, wherein said second pontoons are evenly distributed about said first pontoon.
